(19) United States
(12) Patent Application Publication
(10) Pub. No.: US 2026/0304091 A1
(43) Pub. Date: Oct. 1, 2026

(54) ENHANCED WIRELESS EMERGENCY ALERT RESPONSE USING A TEMPORARY DATA ACCESS REQUEST

(71) Applicant: T-Mobile USA, Inc., Bellevue, WA (US)

(72) Inventors: Manikanta Kumar Teja PENUMATSHA, Redmond, WA (US); Caesar Alexander WHITE, Snoqualmie, WA (US); Jenniffer LUCAS CRUZ, Renton, WA (US); Venkata S N S PIRATLA, Bellevue, WA (US)

(21) Appl. No.: 19/097,844

(22) Filed: Apr. 1, 2025

(51) Int. Cl. H04W 4/90; H04W 4/06; H04W 76/27

(52) U.S. Cl. CPC H04W 4/90; H04W 4/06; H04W 76/27

(57) ABSTRACT

Responses to wireless emergency alert (WEA) messages, from a broadcast message center (BMC), are enhanced by allowing temporary data access by user equipment (UEs) that otherwise do not have data access to websites referenced in WEAs, such as UEs without data plans and UEs that do not have subscriber identity modules (SIMs). When a UE receives a WEA, and attempts to access a website referenced in the WEA to obtain more information about the emergency or suggested action, the UE adds a flag in the request sent to the wireless network (e.g., cellular carrier network). The network recognizes the flag and grants the UE temporary access to that particular website. Additionally, if the UE does not have a SIM, another flag is used to request an RRC connection. The network may monitor the UE's data access attempts, in order to enforce limits on which websites the UE attempts to access.

### BACKGROUND

Wireless Emergency Alerts (WEAs) are short emergency messages sent by authorized government alerting authorities through mobile carriers, broadcast from cellular towers in targeted areas. An AMBER Alert is a type of WEA. However, WEAs are limited to 360 characters, which restricts the amount of information that may be provided in the WEA itself. So, some WEAs contain URLs referencing websites that have additional information about the emergency. When a user sees the WEA on the screen of their user equipment (UE, e.g., cellphone), clicking on the URL opens the website, so the user can learn the additional information.

Unfortunately, UEs without data plans, which includes UEs without subscriber identity modules (SIMs) and UE that lack a data plan of other reasons, cannot access websites, including the websites referenced in the WEAs. This puts those users of those UEs at a disadvantage.

### SUMMARY

The following summary is provided to illustrate examples disclosed herein, but is not meant to limit all examples to any particular configuration or sequence of operations.

Solutions are disclosed that provide for enhancing wireless emergency alert (WEA) response using temporary data access. Examples receive, by a first node of a wireless network, a data access request indicating a user equipment (UE) and comprising a WEA data flag; identify a reference to a remote resource in a WEA message, wherein a default network access of the UE does not include data access to the remote resource; identify the WEA data flag within the data access request; and based on at least identifying the WEA data flag within the data access request, grant, to the UE, temporary data access to the remote resource.

Additional examples receive, by a mobility of a wireless network, from a WEA distribution node, a WEA message comprising a reference to a remote resource and a time indication; forward the WEA message to a base station of the wireless network; and forward, to a session management node of the wireless network, at least the reference to the remote resource and the time indication.

Additional examples receive, by a UE, a WEA message from a wireless network, the WEA message comprising a reference to a remote resource, wherein a default network access of the UE does not include data access to the remote resource; based on at least an attempt to access the remote resource, transmit a first message to the wireless network, the first message comprising a first WEA data flag; and based on at least transmitting the first message with the first WEA data flag, receive content from the remote resource through the wireless network.

### BRIEF DESCRIPTION OF THE DRAWINGS

The disclosed examples are described below with reference to the accompanying drawing figures listed below, wherein:

FIG. 1 illustrates an exemplary architecture that advantageously enhances wireless emergency alert (WEA) responses by allowing temporary data access by user equipment (UEs) that otherwise do not have data access to websites referenced in WEAs;

FIG. 2 illustrates features of the WEA response enhancement of the architecture of FIG. 1;

FIG. 3 illustrates a message sequence diagram of messages that may be used in examples of the architecture of FIG. 1;

FIG. 4 illustrates an exemplary WEA message that may be used in examples of the architecture of FIG. 1;

FIG. 5 illustrates an exemplary message that may be used to obtain a connection for the UE in examples of the architecture of FIG. 1;

FIG. 6 illustrates an exemplary message that may be used to obtain a packet data session for the UE in examples of the architecture of FIG. 1;

FIG. 7 illustrates another exemplary message that may be used to obtain a packet data session for the UE in examples of the architecture of FIG. 1;

FIGS. 8A, 8B, 9A, 9B, and 9C illustrate flowcharts of exemplary operations associated with the architecture of FIG. 1; and

FIG. 10 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Responses to wireless emergency alert (WEA) messages, from a broadcast message center (BMC), are enhanced by allowing temporary data access by user equipment (UEs) that otherwise do not have data access to websites referenced in WEAs, such as UEs without data plans and UEs that do not have subscriber identity modules (SIMs). When a UE receives a WEA, and attempts to access a website referenced in the WEA to obtain more information about the emergency or suggested action, the UE adds a special flag in the request sent to the wireless network (e.g., cellular carrier network). The network recognizes the flag and grants the UE temporary access to that particular website. Additionally, if the UE does not have a SIM, another flag is used to request a radio resource control (RRC) connection. The network may monitor the UE's data access attempts, in order to enforce limits on which websites the UE attempts to access.

Aspects of the disclosure improve public safety by enlarging the number of UE users that are able to obtain the detailed information that is referenced in WEA messages, but is only on websites. For example, whereas UEs that lack SIMs and/or data plans are currently not able to access websites that have detailed information about an emergency, aspects of the disclosure now expand the data access to those UEs using special flags, identified herein as WEA data flags.

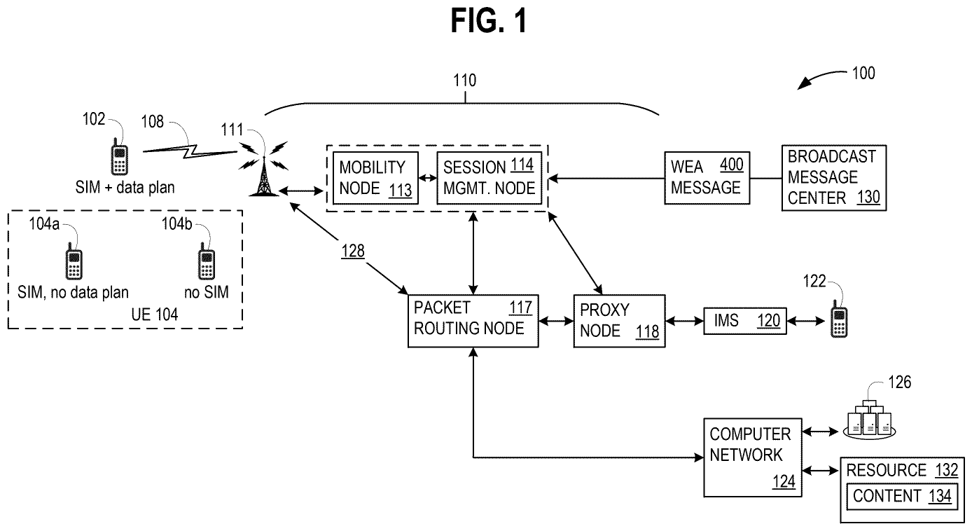

With reference now to the figures, FIG. 1 illustrates an exemplary architecture 100 that advantageously enhances WEA responses by allowing temporary data access by UEs that otherwise do not have data access to websites referenced in WEAs.

A wireless network 110 is illustrated that is serving a UE 102. UE 102 may be an enhanced mobile broadband (eMBB) or cellphone, a fixed wireless access (FWA), internet of things (IoT) device, machine-to-machine (M2M) communication device, a personal computer (PC, e.g., desktop, notebook, tablet, etc.) with a cellular modem, or another telecommunication device capable of using a wireless network. In the scene depicted in FIG. 1, UE 102 is using wireless network 110 for a packet data session to reach a network resource 126 (e.g., a website) across an external packet data computer network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

UE 102 uses an air interface 108 to communicate with a base station 111 of wireless network 110, such that base station 111 is the serving base station for UE 102 (providing the serving cell). In some scenarios, base station 111 may be referred to as a radio access network (RAN). Wireless network 110 has a mobility node 113, a session management node 114, and other components (not shown). Wireless network 110 also has a packet routing node 117 and a proxy node 118. Mobility node 113 and session management node 114 are within a control plane of wireless network 110, and packet routing node 117 is within a data plane (a.k.a. user plane) of wireless network 110.

Base station 111 is in communication with mobility node 113 and packet routing node 117. Mobility node 113 is in communication with session management node 114, which is in communication with packet routing node 117, and proxy node 118. Packet routing node 117 is in communication with proxy node 118 and computer network 124. In some 5G examples, base station 111 comprises a gNodeB (gNB), mobility node 113 comprises an access mobility function (AMF), session management node 114 comprises a session management function (SMF), and packet routing node 117 comprises a user plane function (UPF). In some 4G examples, base station 111 comprises an eNodeB (eNB), mobility node 113 comprises a mobility management entity (MME), session management node 114 comprises a system architecture evolution gateway (SAEGW) control plane (SAEGW-C), and packet routing node 117 comprises an SAEGW-user plane (SAEGW-U). In some examples, proxy node 118 comprises a proxy call session control function (P-CSCF) in both 4G and 5G.

Proxy node 118 is in communication with an internet protocol (IP) multimedia system (IMS) 120, which uses an access gateway (IMS-AGW) in order to provide connectivity to other wireless (cellular) networks, such as for a call with a UE 122 or a public switched telephone system (PSTN, also known as plain old telephone system, POTS). In some examples, proxy node 118 may be considered to be within IMS 120. UE 102 reaches network resource 126 using computer network 124 (or IMS 120, in some examples). Data packets of data traffic 128 to/from UE 102 pass through at least base station 111 and packet routing node 117 on their way from/to computer network 124 or IMS 120 (via proxy node 118).

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

As illustrated in further detail in the remaining figures, wireless network 110 is also serving another UE 104a, which has a SIM but no data plan, and a UE 104b, which does not have a SIM and therefore does not have data access. For simplicity of the following description, UE 104a and UE 104b are referred to, generically, as a UE 104 that lacks data access on wireless network 110. Where the presence of a SIM results in different treatment, the specific examples are described for UE 104a versus UE 104b.

A WEA distribution node 130, illustrated as a BMC, sends a WEA message 400 to wireless network 110 for broadcast to the UEs being served by wireless network 110. WEA message 400 references a remote resource 132 (e.g., a website) with content 134 that includes more detailed information, such as a map or other details. When UE 104 (i.e., UE 104a and/or UE 104b) attempt to access remote resource 132 wireless network 110 makes a temporary exception to allow UE 104 to retrieve content 134 from remote resource 132.

Although FIG. 1 and some of the following figures are described using an example of a cellular network, it should be understood that the teachings herein are applicable to other types of wireless networks. To benefit from the teachings herein, another wireless network, other than a cellular network, should have different tiers of access, some of which permit accessing websites and some of which do not. With such a feature, another type of wireless network, other than a cellular network, may also benefit from the disclosure herein.

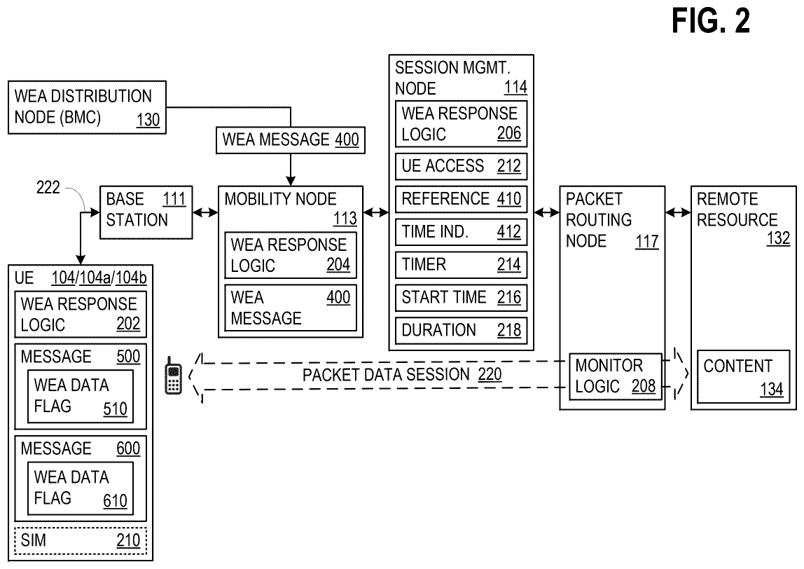

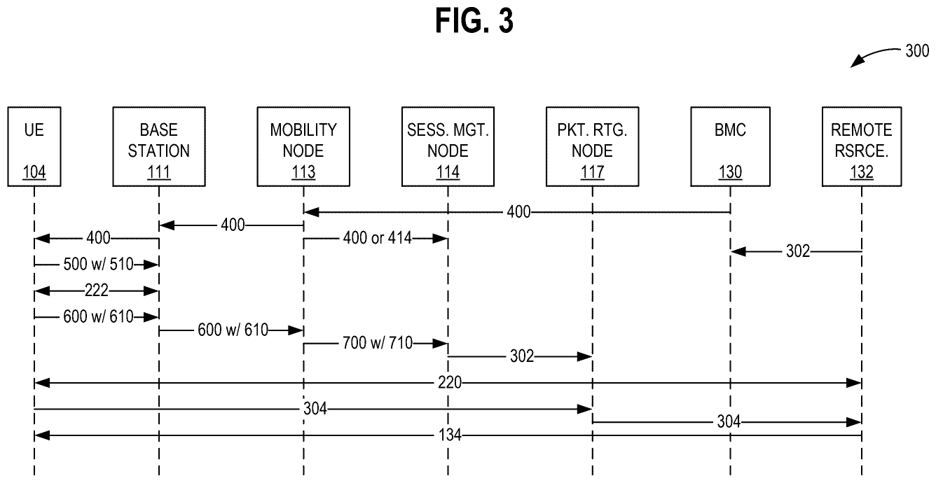

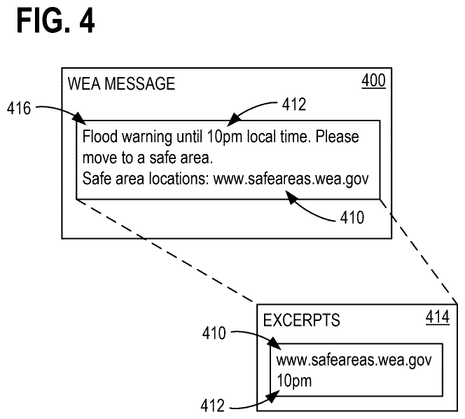

FIG. 2 illustrates features of the WEA response enhancement of architecture 100, and is explained along with FIG. 3. FIG. 3 shows a message sequence diagram 300 of messages that start with WEA distribution node 130 sending WEA message 400 to mobility node 113. Turning briefly to FIG. 4, an example of WEA message 400 is shown. WEA message 400 has a subject 416, shown as “Flood warning . . . ”, a time indication 412, shown as “10 μm local time”, and a reference 410 to remote resource 132. Reference 410 is shown as a uniform resource locator (URL), but may also be a uniform resource name (URN) or a uniform resource identifier (URI) in some examples. In this example, remote resource 132 comprises a website containing information related to subject 416 of WEA message 400. For example, content 134 on remote resource 132 includes maps of areas that are identified as being safe from the announced flood. In some examples, time indication 412 maybe in metadata of a message, rather than displayed.

Also shown is excerpts 414, which includes time indication 412 and reference 410 to remote resource 132. Returning to FIGS. 2 and 3, mobility node 113 has a WEA response logic 204 that forwards either the entirety of WEA message 400 to session management node 114, or else instead extracts excerpts 414 from WEA message 400 and sends excerpts 414 to session management node 114. This way, session management node 114 has at least reference 410 and time indication 412 available to determine whether to grant UE 104 access to remote resource 132, when (and if) UE 104 does make such a request.

Mobility node 113 also forwards WEA message 400 to base station 111, which transmits WEA message 400 to UE 104. UE 104 has a WEA response logic 202 that generates messages 500 and 600, as described below. UE 104 needs a connection 222 (e.g., an RRC connection) with base station 111. At this point, the experience of UE 104a, which has a SIM 210, differs from UE 104b, which does not have a SIM. Both UE 104a and UE 104b send a message 500 (e.g., an RRC request) to base station 111, with a WEA data flag 510, but the contents of the specific versions of message 500 may differ in some examples.

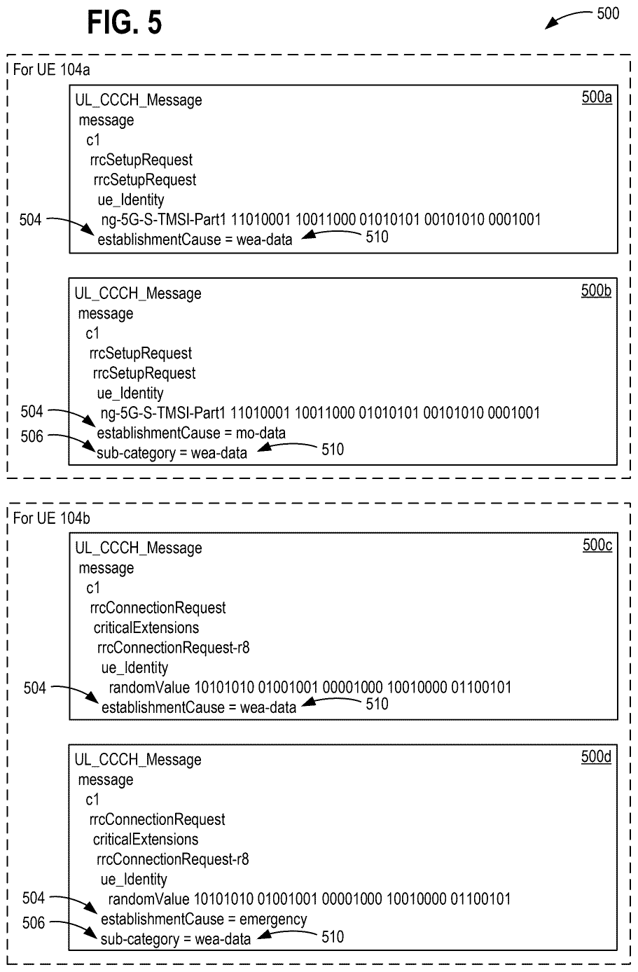

Turning briefly to FIG. 5, four examples of message 500 are shown for 5G. Versions for 4G and other cellular generations may differ slightly. Message 500a is one version of message 500 for UE 104a (with SIM 210), in which WEA data flag 510 comprises “wea-data” within an establishmentCause field 504. Message 500b is another version of message 500 for UE 104a, although WEA data flag 510 (also “wea-data”) is instead in a sub-category field 506 of establishmentCause field 504 and establishmentCause field 504 contains “mo-data”.

Message 500c is one version of message 500 for UE 104b (without a SIM), in which WEA data flag 510 comprises “wea-data” within establishmentCause field 504. Message 500d is another version of message 500 for UE 104b, although WEA data flag 510 (also “wea-data”) is instead in a sub-category field 506 of establishmentCause field 504 and establishmentCause field 504 contains “emergency”. The flag “emergency” may be used for UEs that do not have SIMs when requesting an RRC connection with a base station, whereas UEs with SIMS may use “mo-data”.

Returning to FIGS. 2 and 3, after receiving message 500, connection 222 is established for UE 104, and UE 104 then transmits a message 600, holding a WEA data flag 610, to base station 111. In some examples, message 600 is a non-access stratum (NAS) message.

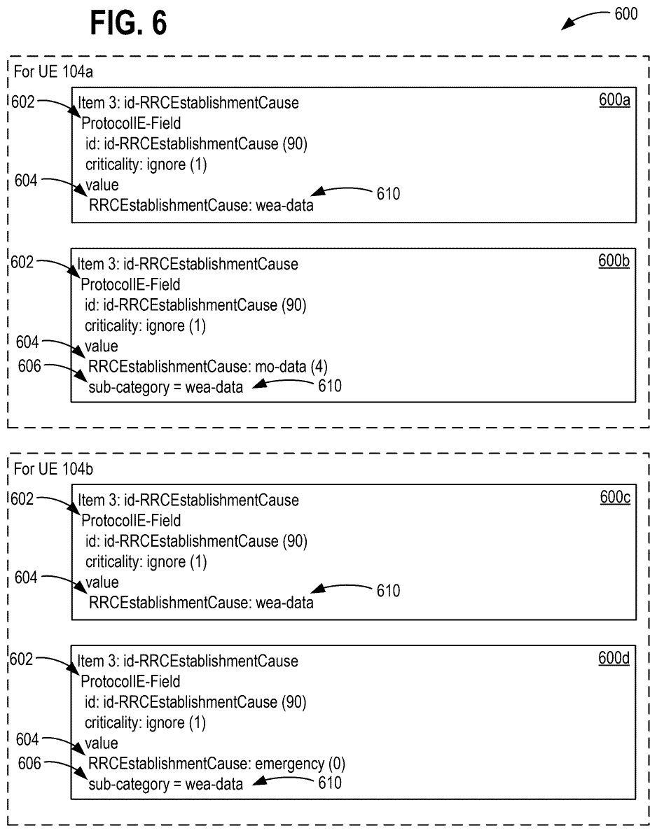

Turning briefly to FIG. 6, four examples of message 600 are shown for 5G. Versions for 4G and other cellular generations may differ slightly. Message 600a is one version of message 600 for UE 104a, in which WEA data flag 610 comprises “wea-data” within an RRCEstablishmentCause field 604, which is within an information element (IE) field 602. Message 600b is another version of message 600 for UE 104a, although WEA data flag 610 (also “wea-data”) is instead in a sub-category field 606 of RRCEstablishmentCause field 604 and RRCEstablishmentCause field 604 contains “mo-data”.

Message 600c is one version of message 600 for UE 104b, in which WEA data flag 610 comprises “wea-data” within RRCEstablishmentCause field 604. Message 600d is another version of message 600 for UE 104b, although WEA data flag 610 (also “wea-data”) is instead in a sub-category field 606 of RRCEstablishmentCause field 604 and RRCEstablishmentCause field 604 contains “emergency”. Similarly as with message 500, the flag “emergency” may be used for UEs that do not have SIMs, whereas UEs with SIMS may use “mo-data”.

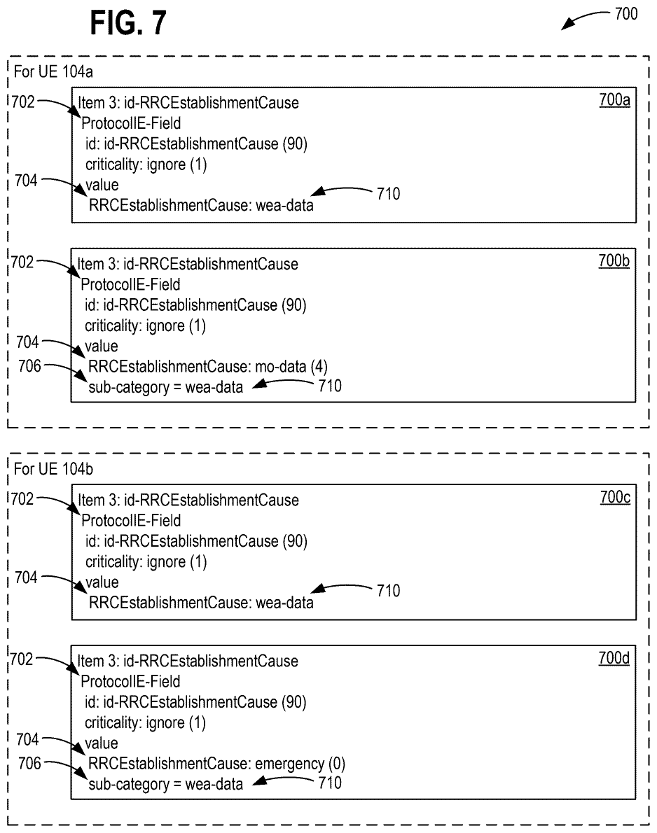

Returning to FIGS. 2 and 3, after receiving message 600, base station 111 forwards message 600 to mobility node 113. Mobility node 113 sends a data access request 700, with a WEA data flag 710, to session management node 114. Turning briefly to FIG. 7, four examples of data access request 700 are shown for 5G. Versions for 4G and other cellular generations may differ slightly. Data access request 700a is one version of data access request 700 for UE 104a, in which WEA data flag 710 comprises “wea-data” within an RRCEstablishmentCause field 704, which is within an IE field 702. Data access request 700b is another version of data access request 700 for UE 104a, although WEA data flag 710 (also “wea-data”) is instead in a sub-category field 706 of RRCEstablishmentCause field 704 and RRCEstablishmentCause field 704 contains “mo-data”.

Data access request 700c is one version of data access request 700 for UE 104b, in which WEA data flag 710 comprises “wea-data” within RRCEstablishmentCause field 704. Data access request 700d is another version of data access request 700 for UE 104b, although WEA data flag 710 (also “wea-data”) is instead in a sub-category field 706 of RRCEstablishmentCause field 704 and RRCEstablishmentCause field 704 contains “emergency”. Similarly as with message 500 and message 600, the flag “emergency” may be used for UEs that do not have SIMs, whereas UEs with SIMS may use “mo-data”.

Returning to FIGS. 2 and 3, session management node 114 has a WEA response logic 206 that checks a default network access 212 of UE 104 upon receiving data access request 700. Default network access 212 may be determined using a subscriber database, such as a unified data management (UDM) in 5G or home subscriber server (HSS) in 4G. Default network access 212 indicates that UE 104 does not have data access to remote resource 132, and may be constrained to services such as voice, SMS, MMS, WEAs, and other similar services.

WEA response logic 206 checks reference 410 to identify whether UE 104 is requesting access to remote resource 132 as identified in WEA message 400, or instead to a different URL, such as a different website (e.g., network resource 126), which will be denied. WEA response logic 206 also checks time indication 412 to identify whether UE 104 is requesting access to remote resource 132 within a permitted timeframe. There are a few options for limiting time. In some examples, time indication 412 acts as a sop time for the temporary data access, possibly with a courtesy margin such as an extra 30 minutes or perhaps 2 hours. In some examples, a timer 214 is used that marks an access start time 216 when UE 104 first requested (and was granted) access to remote resource 132, and permits the access to continue until a duration 218 of the access reaches some predetermine time limit (e.g., 2 hours). Other possibilities may also be used.

Upon WEA response logic 206 determining to grant the data access to UE 104, session management node 114 sends an instruction 302 to packet routing node 117 to establish packet data session 220 for UE 104. In 5G examples, packet data session 220 may a protocol data unit (PDU) session (or packet data unit session). In 4G examples, packet data network (PDN) session. In some examples, packet data session 220 has a quality of service (QoS) class identifier (QCI) value of 9 for 4G or a 5G QoS identifier (5QI) value of 1 or 2.

Packet data session 220 is limited in both scope (i.e., the URLs that may be visited) and time. In some examples, a monitoring logic 208 in packet routing node 117 enforces the limitations, either based on the initial instruction from session management node 114, instruction 302, or monitoring logic 208 and WEA response logic 206 enforce the limitations together. For example, in order to visit a website UE 104 must send a requested reference 304 via packet data session 220 (e.g., to a domain name server, DNS, which is not shown). Requested reference 304 may be a URL, a URN, or a URI. Monitoring logic 208 or WEA response logic 206 compares requested reference 304 with reference 410, and if they are the same, allows requested reference 304 to be used to reach remote resource 132, which returns content 134 to UE 104.

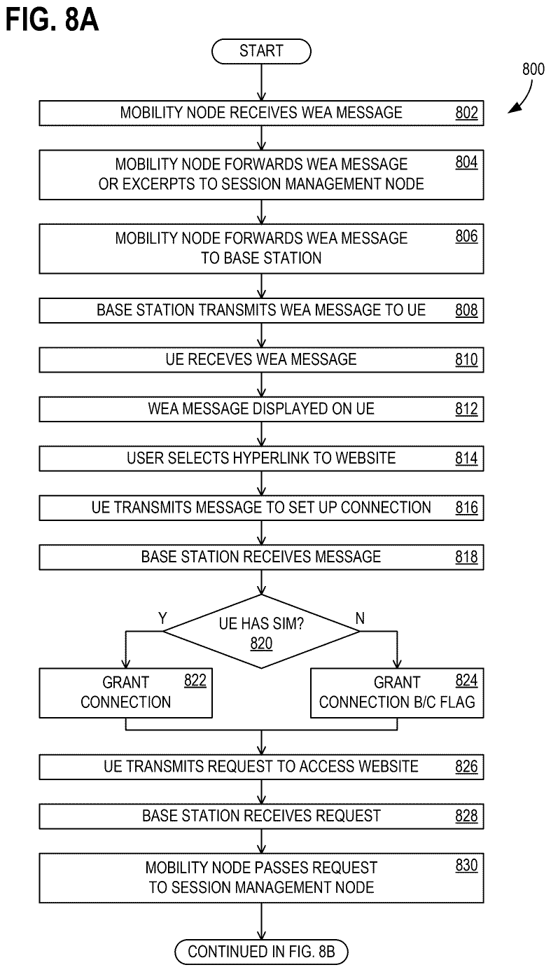

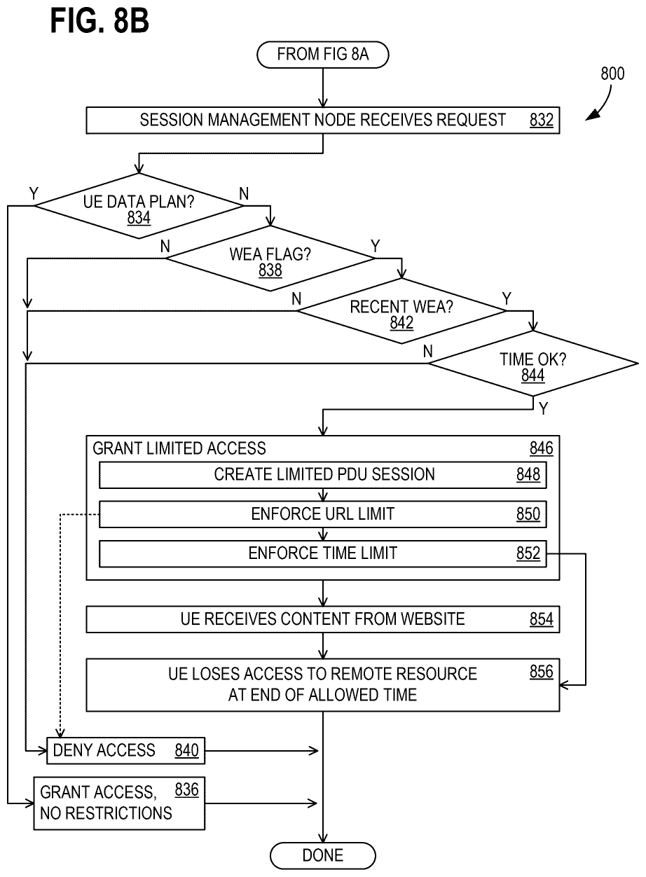

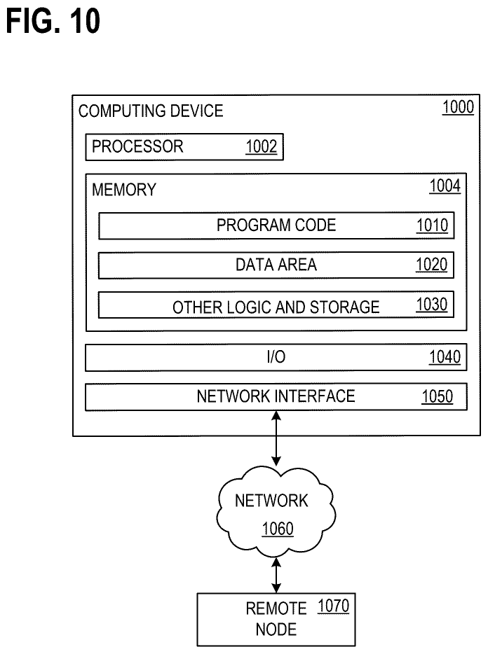

FIGS. 8A and 8B together illustrates a flowchart 800 of exemplary operations associated with examples of architecture 100. In some examples, at least a portion of flowchart 800 may be performed using one or more computing devices 1000 of FIG. 10. Flowchart 800 commences with mobility node 113 receiving WEA message 400 from WEA distribution node 130 in operation 802, as shown in FIG. 8A. WEA message 400 has reference 410 to remote resource 132 and time indication 412.

Mobility node 113 forwards at least reference 410 to remote resource 132 and time indication 412 to session management node 114, in operation 804. In some examples, mobility node 113 forwards the entirety of WEA message 400. In some examples, mobility node 113 extracts excerpts 414 from WEA message 400, such as reference 410 and time indication 412, and forwards excerpts 414, rather than the entirety of WEA message 400. In operation 806, mobility node 113 forwards WEA message 400 to base station 111, and base station 111 transmits WEA message 400 to UE 104 in operation 808.

UE 104 receives WEA message 400 from wireless network 110 in operation 810. However, default network access 212 of UE 104 does not include internet browsing, such as data access to remote resource 132. Instead, default network access 212 of UE 104 limits UE 104 to voice calls, short messages (e.g., SMS, perhaps MMS) including WEA messages, and some other services.

UE 104 displays WEA message 400 in operation 812, and a user of UE 104 selects (e.g., clicks, etc.) reference 410 to remote resource 132 to access remote resource 132 in operation 814. As a result, in operation 816, UE 104 transmits message 500 to wireless network 110 in order to start the process of attempting to access remote resource 132. Message 500 has WEA data flag 510. In some examples, message 500 comprises an RRC request. As will be shown in the following operations of flowchart 800, UE 104 receives content 134 from remote resource 132 through wireless network 110 based on at least transmitting message 500 with WEA data flag 510, and further based on at least transmitting message 600 to wireless network 110. Receiving content 134 from remote resource 132 will include both establishing packet data session 220 with packet routing node 117 of wireless network 110 and receiving content 134 over packet data session 220, as further described below.

Base station 111 receives message 500 from UE 104 in operation 818. Decision operation 820 determines whether UE 102 has SIM 210. If so (UE 104a example), wireless network 110 grants connection 222 to UE 104 in response to UE 104 transmitting (and base station 111 receiving) message 500, in operation 822. If not (UE 104a example), wireless network 110 looks for establishmentCause field 504 or sub-category field 506 of message 500 containing WEA data flag 510 (e.g., wea-data”). If WEA data flag 510 is present, wireless network 110 grants connection 222 to UE 104 in operation 824. Otherwise if WEA data flag 510 is not present, wireless network 110 does not grant connection 222 to UE 104. The description of flowchart 800 proceeds as if connection 222 is granted to UE 104.

In operation 826, based on at least establishing connection 222 with wireless network 110, UE 104 transmits message 600 to wireless network 110. Message 600 has WEA data flag 610. In some examples, message 600 comprises an NAS message. Base station 111 receives message 600 in operation 828. As will be shown in the following operations of flowchart 800, base station will later transmit content 134 from remote resource 132 to UE 104, based on at least receiving message 600 with WEA data flag 610.

Mobility node 113 receives message 600 and sends data access request 700 to session management node 114 in operation 830. Data access request 700 indicates UE 104 and has WEA data flag 710. Flowchart 800 continues in FIG. 8B.

Session management node 114 receives data access request 700 in operation 832. Session management node 114 then determines whether UE 104 has a data plan by examining default network access 212 of UE 104 in decision operation 834. If it had instead been UE 102 requesting to access remote resource 132, because UE 102 has a SIM and a data plan, session management node 114 would grant UE 102 data access and set up packet data session for UE 102, without restrictions, in operation 836.

However, default network access 212 of UE 104 does not include data access to remote resource 132. So, flowchart 800 proceeds to decision operation 838 in which session management node 114 ascertains whether data access request 700 contains WEA data flag 710 (e.g., “wea-data” in RRCEstablishmentCause field 704 or sub-category field 706). If not, data access is denied in operation 840. However, if session management node 114 identifies WEA data flag 710 within data access request 700 in decision operation 838, decision operation 842 determines whether there has been any recent WEAs, such as by having received WEA message 400 or excerpts 414 from mobility node. If not, data access is denied in operation 840.

If there has been a recent WEA, session management node 114 identifies reference 410 to remote resource 132 in WEA message 400 as part of decision operation 842, and decision operation 844 determines whether data access request 700 has been received within a relevant time window, ascertained using time indication 412 identified within either excerpts 414 or WEA message 400 (whichever was received by session management node 114). If not, data access is denied in operation 840.

If, however, data access request 700 is timely, as determined using time indication 412, in operation 846, session management node 114 grants UE 104 temporary data access to remote resource 132, based on at least identifying WEA data flag 710 within data access request 700. Operation 846 is shown as including operations 848-852. In operation 848, session management node 114 establishes packet data session 220 for UE 104 with packet routing node 117. In 5G examples, this may be accomplished by sending a PDU session create message and setting an SMF Policy Enforcement/UPF configuration parameter such that UE 104 is only able to access reference 410.

In operation 850, session management node 114 and/or packet routing node 117 limiting data access by UE 104 (beyond what is allowed by default network access 212) to remote resource 132. That is, either session management node 114 or packet routing node 117 enforces the limitation of data access alone, or in conjunction with the other. This may include comparing requested reference 304, requested by UE 104 in packet data session 220, with reference 410 and denying data access based on at least requested reference 304 differing from reference 410 to remote resource 132. A denial here routes flowchart 800 to operation 840. Session management node 114 also limits duration 218 of the data access to remote resource 132 based on at least time indication 412, in operation 852

When UE 104 is able to access remote resource 132, UE 104 receives content 134 from remote resource 132 in operation 854. However, when the time allotted for the temporary data access expires, packet data session 220 (if still active) is terminated by session management node 114 and/or packet routing node 117 in operation 856. That is, based on at least access start time 216, when UE 104 received content from remote resource 132, and/or based on at least time indication 412 within WEA message 400, UE 104 loses data access to remote resource 132.

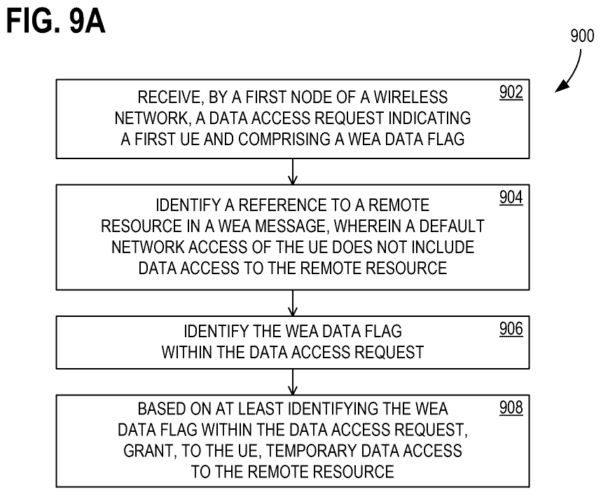

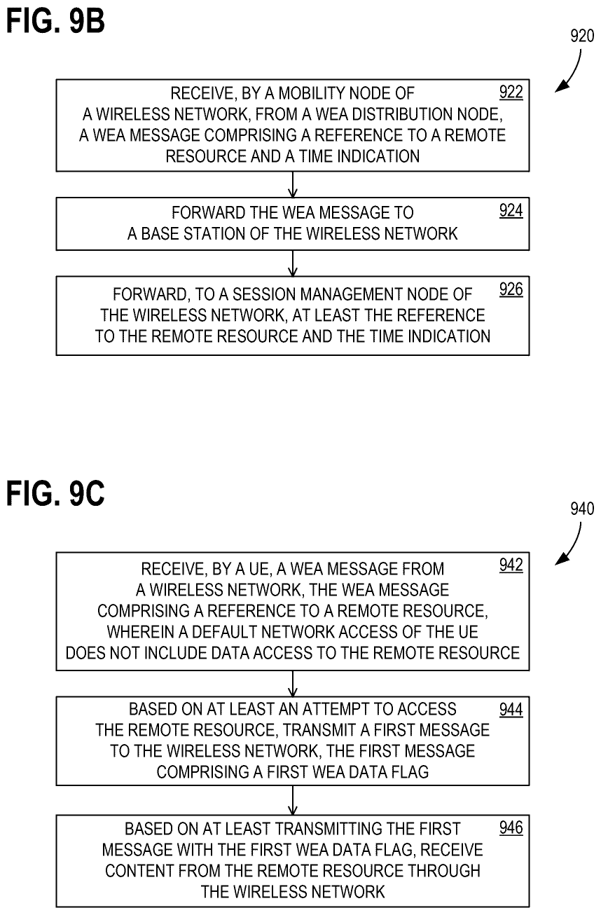

FIG. 9A illustrates a flowchart 900 of exemplary operations associated with architecture 100. In some examples, at least a portion of flowchart 900 may be performed using one or more computing devices 1000 of FIG. 10. Flowchart 900 commences with operation 902, which includes receiving, by a first node of a wireless network, a data access request indicating a UE and comprising a WEA data flag.

Operation 904 includes identifying a reference to a remote resource in a WEA message, wherein a default network access of the UE does not include data access to the remote resource. Operation 906 includes identifying the WEA data flag within the data access request. Operation 908 includes, based on at least identifying the WEA data flag within the data access request, granting, to the UE, temporary data access to the remote resource.

FIG. 9B illustrates a flowchart 920 of exemplary operations associated with architecture 100. In some examples, at least a portion of flowchart 920 may be performed using one or more computing devices 1000 of FIG. 10. Flowchart 920 commences with operation 922, which includes receiving, by a mobility of a wireless network, from a WEA distribution node, a WEA message comprising a reference to a remote resource and a time indication.

Operation 924 includes forwarding the WEA message to a base station of the wireless network. Operation 926 includes forwarding, to a session management node of the wireless network, at least the reference to the remote resource and the time indication.

FIG. 9C illustrates a flowchart 940 of exemplary operations associated with architecture 100. In some examples, at least a portion of flowchart 940 may be performed using one or more computing devices 1000 of FIG. 10. Flowchart 940 commences with operation 942, which includes receiving, by a UE, a WEA message from a wireless network, the WEA message comprising a reference to a remote resource, wherein a default network access of the UE does not include data access to the remote resource.

Operation 944 includes, based on at least an attempt to access the remote resource, transmitting a first message to the wireless network, the first message comprising a first WEA data flag. Operation 946 includes, based on at least transmitting the first message with the first WEA data flag, receiving content from the remote resource through the wireless network.

FIG. 10 illustrates a block diagram of computing device 1000 that may be used as any component described herein that may require computational or storage capacity (e.g., a computer storage device). Computing device 1000 has at least a processor 1002 and a memory 1004 that holds program code 1010, data area 1020, and other logic and storage 1030. Memory 1004 is any device allowing information, such as computer executable instructions and/or other data, to be stored and retrieved. For example, memory 1004 may include one or more random access memory (RAM) modules, flash memory modules, hard disks, solid-state disks, persistent memory devices, and/or optical disks. Program code 1010 comprises computer executable instructions and computer executable components including instructions used to perform operations described herein. Data area 1020 holds data used to perform operations described herein. Memory 1004 also includes other logic and storage 1030 that performs or facilitates other functions disclosed herein or otherwise required of computing device 1000. An input/output (I/O) component 1040 facilitates receiving input from users and other devices and generating displays for users and outputs for other devices. A network interface 1050 permits communication over external computer network 1060 (e.g., computer network 124) with a remote node 1070, which may represent another implementation of computing device 1000. For example, a remote node 1070 may represent another of the above-noted nodes within architecture 100.

### ADDITIONAL EXAMPLES

An example system comprises: a processor; and a computer-readable medium storing instructions that are operative upon execution by the processor to: receive, by a first node of a wireless network, a data access request indicating a UE and comprising a WEA data flag; identify a reference to a remote resource in a WEA message, wherein a default network access of the UE does not include data access to the remote resource; identify the WEA data flag within the data access request; and based on at least identifying the WEA data flag within the data access request, grant, to the UE, temporary data access to the remote resource.

Another example system comprises: a processor; and a computer-readable medium storing instructions that are operative upon execution by the processor to: receive, by a mobility of a wireless network, from a WEA distribution node, a WEA message comprising a reference to a remote resource and a time indication; forward the WEA message to a base station of the wireless network; and forward, to a session management node of the wireless network, at least the reference to the remote resource and the time indication.

Another example system comprises: a processor; and a computer-readable medium storing instructions that are operative upon execution by the processor to: receive, by a UE, a WEA message from a wireless network, the WEA message comprising a reference to a remote resource, wherein a default network access of the UE does not include data access to the remote resource; based on at least an attempt to access the remote resource, transmit a first message to the wireless network, the first message comprising a first WEA data flag; and based on at least transmitting the first message with the first WEA data flag, receive content from the remote resource through the wireless network.

An example method of wireless communication comprises: receiving, by a first node of a wireless network, a data access request indicating a UE and comprising a WEA data flag; identifying a reference to a remote resource in a WEA message, wherein a default network access of the UE does not include data access to the remote resource; identifying the WEA data flag within the data access request; and based on at least identifying the WEA data flag within the data access request, granting, to the UE, temporary data access to the remote resource.

Another example method of wireless communication comprises: receiving, by a mobility of a wireless network, from a WEA distribution node, a WEA message comprising a reference to a remote resource and a time indication; forwarding the WEA message to a base station of the wireless network; and forwarding, to a session management node of the wireless network, at least the reference to the remote resource and the time indication.

Another example method of wireless communication comprises: receiving, by a UE, a WEA message from a wireless network, the WEA message comprising a reference to a remote resource, wherein a default network access of the UE does not include data access to the remote resource; based on at least an attempt to access the remote resource, transmitting a first message to the wireless network, the first message comprising a first WEA data flag; and based on at least transmitting the first message with the first WEA data flag, receiving content from the remote resource through the wireless network.

One or more example computer storage devices has computer-executable instructions stored thereon, which, upon execution by a computer, cause the computer to perform operations comprising: receiving, by a first node of a wireless network, a data access request indicating a UE and comprising a WEA data flag; identifying a reference to a remote resource in a WEA message, wherein a default network access of the UE does not include data access to the remote resource; identifying the WEA data flag within the data access request; and based on at least identifying the WEA data flag within the data access request, granting, to the UE, temporary data access to the remote resource.

One or more additional example computer storage devices has computer-executable instructions stored thereon, which, upon execution by a computer, cause the computer to perform operations comprising: receiving, by a mobility of a wireless network, from a WEA distribution node, a WEA message comprising a reference to a remote resource and a time indication; forwarding the WEA message to a base station of the wireless network; and forwarding, to a session management node of the wireless network, at least the reference to the remote resource and the time indication.

One or more additional example computer storage devices has computer-executable instructions stored thereon, which, upon execution by a computer, cause the computer to perform operations comprising: receiving, by a UE, a WEA message from a wireless network, the WEA message comprising a reference to a remote resource, wherein a default network access of the UE does not include data access to the remote resource; based on at least an attempt to access the remote resource, transmitting a first message to the wireless network, the first message comprising a first WEA data flag; and based on at least transmitting the first message with the first WEA data flag, receiving content from the remote resource through the wireless network.

Alternatively, or in addition to the other examples described herein, examples include any combination of the following:
the first node of the wireless network comprises a session management node;
the session management node comprises an SMF or an SAEGW-C;
the second node of the a wireless network comprises a mobility node;
the mobility node comprises an AMF or an MME;
the first message comprises an RRC request;
the second message comprises an NAS message;
receiving, by a second node of the wireless network, from a WEA distribution node, the WEA message;
forwarding, by the second node of the wireless network, to the first node of the wireless network, the WEA message or excerpts of the WEA message;
the excerpts of the WEA message comprise the reference to the remote resource and the time indication within the WEA message;
forwarding at least the reference to the remote resource and the time indication comprises forwarding the WEA message or excerpts of the WEA message;
transmitting, by the base station, to a UE, the WEA message;
displaying, on the UE, the WEA message;
selecting the reference to the remote resource to access the remote resource;
receiving, by the base station, from the UE, a first message comprising a first WEA data flag;
based on at least establishing the connection with the wireless network, transmitting a second message to the wireless network, the second message comprising a second WEA data flag;
receiving, by the base station, from the UE, a second message comprising a second WEA data flag;
based on at least receiving the second message with the second WEA data flag, transmitting content from the remote resource to the UE;
based on at least an access start time when the UE received content from the remote resource, and/or based on at least the time indication within the WEA message, losing data access, by the UE, to the remote resource;
receiving the content from the remote resource is further based on at least transmitting the second message to the wireless network;
receiving the content from the remote resource comprises establishing a packet data session with a packet routing node of the wireless network;
receiving the content from the remote resource further comprises receiving the content over the packet data session;
the packet data session has a QCI value of 9 or a 5QI value of 1 or 2;
granting the data access to the remote resource comprises establishing, a packet data session for the UE with a packet routing node of the wireless network;
granting the data access to the remote resource further comprises limiting data access by the UE, beyond the default network access, to the remote resource;
the first node of the wireless network and/or the packet routing node enforces the limitation of data access by the UE;
enforcing the limitation of data access by the UE comprises comparing a reference requested by the UE in the packet data session with the reference to the remote resource;
enforcing the limitation of data access by the UE further comprises denying data access based on at least the requested reference differing from the reference to the remote resource;
limiting, by the wireless network, data access by the UE, beyond the default network access, to the remote resource;
the default network access of the UE limits the UE to voice calls and short messages, including WEA messages;
the WEA message further comprises the time indication;
identifying the time indication associated with the WEA message;
limiting a duration of the data access to the remote resource based on at least the time indication;
the UE has a SIM;
the RRCEstablishmentCause field of the data access request comprises mo-data;
based on at least transmitting the first message to the wireless network, establishing a connection with the wireless network;
based on at least receiving the first message, granting an RRC connection to the UE;
the establishmentCause field of the first message comprises mo-data
the RRCEstablishmentCause field of the second message comprises mo-data;
the UE does not have a SIM;
the RRCEstablishmentCause field of the data access request comprises emergency;
based on at least the establishmentCause field of the first message comprising emergency, granting an RRC connection to the UE;
based on at least the establishmentCause field of the first message not comprising emergency, not granting an RRC connection to the UE;
the establishmentCause field of the first message comprises emergency;
the RRCEstablishmentCause field of the second message comprises emergency;
the reference to the remote resource comprises a URL, or a URN, or a URI;
the requested reference comprises a URL, or a URN, or a URI;
the remote resource comprises a website;
the website contains information related to a subject of the WEA message;
the content from the remote resource is related to a subject of the WEA message;
the data access request comprises an IE field comprising an RRCEstablishmentCause field;
the WEA data flag comprises wea-data within the RRCEstablishmentCause field;
the WEA data flag comprises wea-data within a sub-category field of the RRCEstablishmentCause field;
the first WEA data flag comprises wea-data within an establishmentCause field of the first message;
the first WEA data flag comprises wea-data within a sub-category field of the establishmentCause field of the first message;
the second WEA data flag comprises wea-data within an RRCEstablishmentCause field of the second message; and
the second WEA data flag comprises wea-data within a sub-category field of the RRCEstablishmentCause field of the second message.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
receiving, by a user equipment (UE), a wireless emergency alert (WEA) message from a wireless network, the WEA message comprising a reference to a remote resource, wherein a default network access of the UE does not include data access to the remote resource;
based on at least an attempt to access the remote resource, transmitting a first message to the wireless network, the first message comprising a first WEA data flag; and
based on at least transmitting the first message with the first WEA data flag, receiving content from the remote resource through the wireless network.

2. The method of claim 1, further comprising:
based on at least transmitting the first message to the wireless network, establishing a connection with the wireless network; and
based on at least establishing the connection with the wireless network, transmitting a second message to the wireless network, the second message comprising a second WEA data flag, wherein receiving the content from the remote resource is further based on at least transmitting the second message to the wireless network.

3. The method of claim 2,
wherein the first message comprises a radio resource control (RRC) request; and
wherein the second message comprises a non-access stratum (NAS) message.

4. The method of claim 3,
wherein the first WEA data flag comprises wea-data within an establishmentCause field of the first message or comprises wea-data within a sub-category field of the establishmentCause field of the first message; and
wherein the second WEA data flag comprises wea-data within an RRCEstablishmentCause field of the second message or comprises wea-data within a sub-category field of the RRCEstablishmentCause field of the second message.

5. The method of claim 4,
wherein the UE has a subscriber identity module (SIM), wherein the establishmentCause field of the first message comprises mo-data, and wherein the RRCEstablishmentCause field of the second message comprises mo-data; or
wherein the UE does not have a SIM, wherein the establishmentCause field of the first message comprises emergency, and wherein the RRCEstablishmentCause field of the second message comprises emergency.

6. The method of claim 1, further comprising:
based on at least an access start time when the UE received content from the remote resource, and/or based on at least a time indication within the WEA message, losing data access, by the UE, to the remote resource.

7. The method of claim 1, further comprising:
limiting, by the wireless network, data access by the UE, beyond the default network access, to the remote resource.

8. The method of claim 1,
wherein the reference to the remote resource comprises a uniform resource locator (URL), a uniform resource name (URN), or a uniform resource identifier (URI); and/or
wherein the remote resource comprises a website.

9. A system comprising:
a processor; and
a computer-readable medium storing instructions that are operative upon execution by the processor to:
receive, by a user equipment (UE), a wireless emergency alert (WEA) message from a wireless network, the WEA message comprising a reference to a remote resource, wherein a default network access of the UE does not include data access to the remote resource;
based on at least an attempt to access the remote resource, transmit a first message to the wireless network, the first message comprising a first WEA data flag; and
based on at least transmitting the first message with the first WEA data flag, receive content from the remote resource through the wireless network.

10. The system of claim 9, wherein the instructions are further operative to:
based on at least transmitting the first message to the wireless network, establish a connection with the wireless network; and
based on at least establishing the connection with the wireless network, transmit a second message to the wireless network, the second message comprising a second WEA data flag, wherein receiving the content from the remote resource is further based on at least transmitting the second message to the wireless network.

11. The system of claim 10,
wherein the first message comprises a radio resource control (RRC) request; and
wherein the second message comprises a non-access stratum (NAS) message.

12. The system of claim 11,
wherein the first WEA data flag comprises wea-data within an establishmentCause field of the first message or comprises wea-data within a sub-category field of the establishmentCause field of the first message; and
wherein the second WEA data flag comprises wea-data within an RRCEstablishmentCause field of the second message or comprises wea-data within a sub-category field of the RRCEstablishmentCause field of the second message.

13. The system of claim 12,
wherein the UE has a subscriber identity module (SIM), wherein the establishmentCause field of the first message comprises mo-data, and wherein the RRCEstablishmentCause field of the second message comprises mo-data; or
wherein the UE does not have a SIM, wherein the establishmentCause field of the first message comprises emergency, and wherein the RRCEstablishmentCause field of the second message comprises emergency.

14. The system of claim 9, wherein the instructions are further operative to:
based on at least an access start time when the UE received content from the remote resource, and/or based on at least a time indication within the WEA message, lose data access, by the UE, to the remote resource.

15. One or more computer storage devices having computer-executable instructions stored thereon, which, upon execution by a computer, cause the computer to perform operations comprising:
receiving, by a user equipment (UE), a wireless emergency alert (WEA) message from a wireless network, the WEA message comprising a reference to a remote resource, wherein a default network access of the UE does not include data access to the remote resource;
based on at least an attempt to access the remote resource, transmitting a first message to the wireless network, the first message comprising a first WEA data flag; and
based on at least transmitting the first message with the first WEA data flag, receiving content from the remote resource through the wireless network.

16. The one or more computer storage devices of claim 15, wherein the operations further comprise:
based on at least transmitting the first message to the wireless network, establishing a connection with the wireless network; and
based on at least establishing the connection with the wireless network, transmitting a second message to the wireless network, the second message comprising a second WEA data flag, wherein receiving the content from the remote resource is further based on at least transmitting the second message to the wireless network.

17. The one or more computer storage devices of claim 16, wherein the operations further comprise:
wherein the first message comprises a radio resource control (RRC) request; and
wherein the second message comprises a non-access stratum (NAS) message.

18. The one or more computer storage devices of claim 17,
wherein the first WEA data flag comprises wea-data within an establishmentCause field of the first message or comprises wea-data within a sub-category field of the establishmentCause field of the first message; and
wherein the second WEA data flag comprises wea-data within an RRCEstablishmentCause field of the second message or comprises wea-data within a sub-category field of the RRCEstablishmentCause field of the second message.

19. The one or more computer storage devices of claim 18, wherein the operations further comprise:
wherein the UE has a subscriber identity module (SIM), wherein the establishmentCause field of the first message comprises mo-data, and wherein the RRCEstablishmentCause field of the second message comprises mo-data; or
wherein the UE does not have a SIM, wherein the establishmentCause field of the first message comprises emergency, and wherein the RRCEstablishmentCause field of the second message comprises emergency.

20. The one or more computer storage devices of claim 15, wherein the operations further comprise:
based on at least an access start time when the UE received content from the remote resource, and/or based on at least a time indication within the WEA message, losing data access, by the UE, to the remote resource.
